(19) United States
(12) Patent Application Publication
(10) Pub. No.: US 2022/0309892 A1
(43) Pub. Date: Sep. 29, 2022

(54) Intrusion Prevention Device

(71) Applicant: Clifford Odoi, Fallbrook, CA (US)

(72) Inventor: Clifford Odoi, Fallbrook, CA (US)

(21) Appl. No.: 17/214,668

(22) Filed: Mar. 26, 2021

(51) Int. Cl. G08B 15/00; G08B 13/189; G08B 3/10; H04R 1/02; H04N 5/76; H04N 7/18; F41H 9/00

(52) U.S. Cl. CPC G08B 15/00; G08B 13/189; G08B 3/10; H04R 1/028; H04N 5/76; H04N 7/18; F41H 9/00; G01S 19/14

(57) ABSTRACT

An intrusion prevention device running a program thereon and communicably connected to an external control device, the intrusion prevention device including a main body to removably connect to at least a portion of a building, a primary nozzle movably disposed on at least a portion of the main body, at least one sensor disposed on at least a portion of the main body to detect a presence of at least one hostile third party, such that the primary nozzle dispenses a lachrymatory agent toward the at least one hostile third party in response to a determination that a threat exists, a camera disposed on at least a portion of the main body to record the at least one hostile third party thereon using at least one of at least one picture and at least one video, a speaker disposed on at least a portion of the main body to emit at least one alarm sound in response to the determination that a threat exists, and at least one security light disposed on at least a portion of the main body to illuminate a surrounding area in response to the determination that a threat exists.

### BACKGROUND

### 1. Field

The present general inventive concept relates generally to building safety, and particularly, to an intrusion prevention device.

### 2. Description of the Related Art

Property theft and burglary are among the most committed crimes in modern society. Homeowners should always be prepared for the possibility of an intrusion as it can sometimes result in a dangerous situation. Home security systems including modern sensors and cameras have proven to be an effective means of identifying intruders after they arrive at and/or leave the premises, but are ineffective in stopping dangerous intruders during commission of a crime.

Sadly, many criminals succeed in escaping without repercussions which leaves the homeowners with no recourse. Also, even if the criminal is apprehended, the homeowners lose money, suffer injury, and/or death.

Therefore, there is a need for a building safety device that prevents intrusion of a building.

### SUMMARY

The present general inventive concept provides an intrusion prevention device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an intrusion prevention device running a program thereon and communicably connected to an external control device, the intrusion prevention device including a main body to removably connect to at least a portion of a building, a primary nozzle movably disposed on at least a portion of the main body, at least one sensor disposed on at least a portion of the main body to detect a presence of at least one hostile third party, such that the primary nozzle dispenses a lachrymatory agent toward the at least one hostile third party in response to a determination that a threat exists, a camera disposed on at least a portion of the main body to record the at least one hostile third party thereon using at least one of at least one picture and at least one video, a speaker disposed on at least a portion of the main body to emit at least one alarm sound in response to the determination that a threat exists, and at least one security light disposed on at least a portion of the main body to illuminate a surrounding area in response to the determination that a threat exists.

The main body may include a top portion, a bottom portion disposed at a first end on at least a portion of the top portion, a telescopic portion telescopically disposed on at least a portion of a second end of the bottom portion to move from retracted within the bottom portion in a first position to at least partially extended away from the bottom portion in a second position, and move from extended away from the bottom portion in the second position to retracted within the bottom portion in the first position, and a rotating portion rotatably disposed on at least a portion of the telescopic portion to rotate clockwise in a first rotating direction or rotate counterclockwise in a second rotating direction.

The intrusion prevention device may further include an auxiliary nozzle disposed on at least a portion of the rotating portion to dispense the lachrymatory agent therefrom toward the at least one hostile third party in response to the determination that a threat exists.

The at least one sensor may detect the presence of the at least one hostile third party based on movement within a predetermined distance away from the at least one sensor.

The at least one sensor may detect the presence of the at least one hostile third party based on a sound of footsteps within a predetermined distance away from the at least one sensor.

The intrusion prevention device may further include a control unit disposed within at least a portion of the main body to receive commands from the external control device to configure at least one of the primary nozzle, the at least one sensor, the camera, the speaker, and the at least one security light.

The control unit may determine the threat exists based on a combination of the presence of the at least one hostile third party and the at least one hostile third party is a person.

The control unit may transmit a global positioning system (GPS) signal to another external control device of at least one friendly third party in response to the determination that a threat exists.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front perspective view of an intrusion prevention device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Intrusion Prevention Device 100
Main Body 110
Top Portion 111
Bottom Portion 112
Telescopic Portion 113
Rotating Portion 114
Primary Nozzle 120
Movable Portion 121
Auxiliary Nozzle 130
Lachrymatory Agent Container 140
Sensor 150
Camera 160
Speaker 170
Security Lights 180
Control Unit 190
Processing Unit 191
Communication Unit 192
Storage Unit 193
Power Source 194

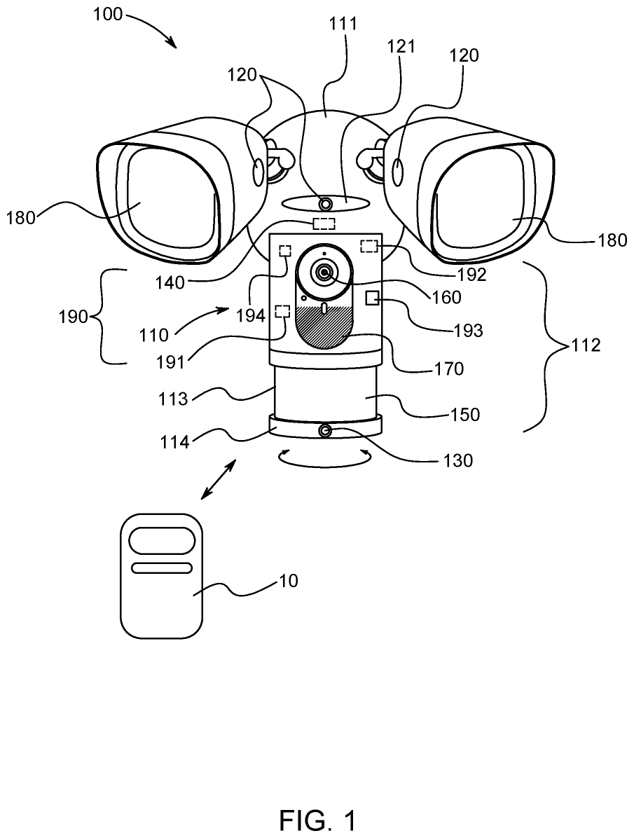

FIG. 1 illustrates a front perspective view of an intrusion prevention device 100, according to an exemplary embodiment of the present general inventive concept.

The intrusion prevention device 100 may be constructed from at least one of metal, plastic, wood, glass, and rubber, etc., but is not limited thereto.

The intrusion prevention device 100 may include a main body 110, a primary nozzle 120, an auxiliary nozzle 130, a lachrymatory agent container 140, at least one sensor 150, a camera 160, a speaker 170, a plurality of security lights 180, and a control unit 190, but is not limited thereto.

The main body 110 may include a top portion 111, a bottom portion 112, a telescopic portion 113, and a rotating portion 114, but is not limited thereto.

The main body 110 may be removably connected to at least a portion of a building, such as a wall of the building. The top portion 111 may be disposed on at least a portion of a first end of the bottom portion 112. Referring to FIG. 1, the bottom portion 112 is illustrated to have a cylindrical shape. However, the bottom portion 112 may have a rectangular prism shape, conical, triangular, pentagonal, hexagonal heptagonal, octagonal, or any other shape known to one of ordinary skill in the art, but is not limited thereto.

The telescopic portion 113 may be movably (i.e. telescopically) disposed on at least a portion of a second end of the bottom portion 112. More specifically, referring again to FIG. 1, the telescopic portion 113 may move from retracted within the bottom portion 112 in a first position to at least partially extended away from the bottom portion 112 in a second position. Conversely, the telescopic portion 113 may move from extended away from the bottom portion 112 in the second position to retracted within the bottom portion 112 in the first position.

The rotating portion 114 may be movably (i.e. rotatably) disposed on at least a portion of the telescopic portion 113. More specifically, the rotating portion 114 may rotate three hundred sixty degrees (360°) in a first rotating direction (i.e. clockwise) or a second rotating direction (i.e. counterclockwise).

The primary nozzle 120 may include a movable portion 121, but is not limited thereto.

The primary nozzle 120 may be movably (i.e. slidably) disposed on at least a portion of the top portion 111 via the movable portion 121. The primary nozzle 120 may dispense (i.e. spray) a lachrymatory agent therefrom. Moreover, the primary nozzle 120 may move in a first lateral direction or a second lateral direction in response to movement of the movable portion 121 via a motor. As such, the primary nozzle 120 may be oriented in different positions.

The auxiliary nozzle 130 may be disposed on at least a portion of the rotating portion 114. As such, the auxiliary nozzle 130 may move (i.e. rotate) in response to movement of the rotating portion 114. Additionally, the primary nozzle 120 may dispense (i.e. spray) the lachrymatory agent therefrom.

The lachrymatory agent container 140 may be disposed within at least a portion of the top portion 111 and/or the bottom portion 112, and may be connected to the primary nozzle 120 and/or the auxiliary nozzle 130, such as through a conduit (i.e., a pipe). Moreover, the lachrymatory agent container 140 may store the lachrymatory agent therein. Also, the lachrymatory agent may include a pepper spray, an oleoresin capsicum spray, a capsaicin spray, a pelargonic acid vanillylamide (PAVA), a bromoacetone spray, a phenacyl chloride (CN) spray, and/or a tear gas, but is not limited thereto. As such, the primary nozzle 120 and/or the auxiliary nozzle 130 may disable and/or incapacitate at least one hostile third party (e.g., a thief, a burglar, an intruder) in response to being sprayed.

The at least one sensor 150 may include a movement sensor, a temperature sensor, and/or a sound sensor, but is not limited thereto.

The at least one sensor 150 may be disposed on at least a portion of the telescopic portion 113. However, the at least one sensor 150 may be disposed on at least a portion of the top portion 111 and/or any other portion of the bottom portion 112. The at least one sensor 150 may detect a presence of the at least one hostile third party in response to a movement within a predetermined distance away from the at least one sensor 150, such as one foot, two feet, three feet, five feet, etc. Alternatively, and/or in addition thereto, the at least one sensor 150 may detect a presence of a sound of footsteps within the predetermined distance from the at least one sensor 150.

Also, the at least one sensor 150 may detect the presence of the at least one hostile third party based on a change in temperature within the predetermined distance away from the at least one sensor 150, such as an increase in temperature due to body heat of the at least one hostile third party of at least five degrees, ten degrees, twenty degrees, or more. Accordingly, the at least one sensor 150 may transmit an alert signal therefrom.

The camera 160 may include any type of camera known to one of ordinary skill in the art, including, but not limited to, an action camera, an animation camera, an autofocus camera, a box camera, a camcorder, a camera phone, a compact camera, a dashboard camera (i.e., a Dashcam), a digital camera, a field camera, a FIREWIRE camera, a helmet camera, a high-speed camera, an instant camera, a keychain camera, a live-preview digital camera, a movie camera, an omnidirectional camera, a pinhole camera, a pocket camera, a pocket video camera, a rangefinder camera, a reflex camera, a remote camera, a stereo camera, a still camera, a still video camera, a subminiature camera, a system camera, a thermal imaging camera, a thermographic camera, a traffic camera, a traffic enforcement camera, a twin-lens reflex camera, a video camera, a view camera, a webcam, a WRIGHT camera, a ZENITH camera, a zoom-lens reflex camera.

The camera 160 may be disposed on at least a portion of the bottom portion 112. The camera 160 may record at least one picture and/or at least one video thereon, such as the at least one hostile third party and/or a surrounding environment.

The speaker 170 may be disposed on at least a portion of the bottom portion 112. The speaker 170 may emit at least one alarm sound (e.g., a beep, a ring, a siren) therefrom.

Each of the plurality of security lights 180 may include an incandescent bulb, a light emitting diode (LED), a fluorescent lamp, and a halogen lamp, but is not limited thereto.

Although the plurality of security lights 180 are described in plurality, the plurality of security lights 180 may be a single security light 180.

The plurality of security lights 180 may be disposed on at least a portion of the top portion 111. The plurality of security lights 180 may illuminate a surrounding area in response to turning on. Moreover, the plurality of security lights 180 may flash (i.e. blink) and/or change to different colors while turned on to indicate an emergency situation (e.g., a theft, a burglary, an intrusion).

The control unit 190 may include a processing unit 191, a communication unit 192, a storage unit 193, and a power source 194, but is not limited thereto.

The processing unit 191 (or central processing unit, CPU) may include electronic circuitry to carry out instructions of a computer program by performing basic arithmetic, logical, control and input/output (I/O) operations specified by the instructions. The processing unit 191 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 191 may also include a microprocessor and a microcontroller.

The communication unit 192 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit 193 may include a random access memory (RAM), a read-only memory (ROM), a hard disk, a flash drive, a database connected to the Internet, cloud-based storage, Internet-based storage, or any other type of storage unit.

The processing unit 191 may access the Internet via the communication unit 192 to allow a user to access a website, and/or may allow a mobile application and/or the software application to be executed using the processing unit 191. For ease of description, the mobile and/or the software application will be hereinafter referred to as an app. The app may be downloaded from the Internet to be stored on the storage unit 193.

The control unit 190 may be disposed within at least a portion of the top portion 111 and/or the bottom portion 112.

An external control device 10 (e.g., a mobile device, a cell phone, a personal digital assistant (PDA), a tablet computer, a laptop computer) may also download the app to control and/or configure the operation of the primary nozzle 120, the auxiliary nozzle 130, the at least one sensor 150, the camera 160, the speaker 170, and/or the plurality of security lights 180 using the control unit 190.

The processing unit 191 executing the app may receive the alert signal from the at least one sensor 150 through the communication unit 192. Moreover, the processing unit 191 executing the app may receive the at least one picture and/or the at least one video from the camera 160 to determine whether the at least one hostile third party is a person based on characteristics of a person as programmed within the app, such as walking posture and/or facial features received on the camera 160. The processing unit 191 executing the app may conclude that no threat exists in an absence of the characteristics of the person. In other words, the processing unit 191 executing the app may conclude that no threat exists from vehicles and/or animals.

However, the processing unit 191 executing the app may determine a threat exists based on a combination of receiving the alert signal from the at least one sensor 150 and/or receiving the at least one picture and/or the at least one video from the camera 160, such that the camera 160 may track (i.e. follows) the at least one hostile third party. Furthermore, the primary nozzle 120 may dispense the lachrymatory agent from the lachrymatory agent container 140 toward the at least one hostile third party in response to receiving a dispense command from the processing unit 191. Alternatively, and/or in addition thereto, the auxiliary nozzle 130 may dispense the lachrymatory agent from the lachrymatory agent container 140 toward the at least one hostile third party in response to receiving the dispense command from the processing unit 191.

Simultaneously, the speaker 170 may emit the at least one alarm sound in response to receiving an alarm signal from the processing unit 191. Also, the plurality of lights 180 may illuminate by flashing in response to receiving the alarm signal from the processing unit 191 as determined by the app. Alternatively, the speaker 170 may emit the at least one alarm sound after a predetermined period of time, such as five seconds and/or ten seconds based on configurations from the app using the external control device 10.

Also, the external control device 10 using the app may immediately activate the primary nozzle 120, the auxiliary nozzle 130, the at least one sensor 150, the camera 160, the speaker 170, and/or the plurality of security lights 180.

The communication unit 192 may transmit a GPS signal therefrom to another external control device of at least one friendly third party (e.g., a family member, a friend, police, a home security company, a neighbor, a homeowner association). As such, the communication unit 192 may notify the at least one friendly third party of a location of the building where the at least one hostile third party may be committing a crime and/or is attempting to commit a crime.

The power source 194 may include a battery, a solar cell, and a power inlet, but is not limited thereto.

The power source 194 may provide power to the primary nozzle 120, the auxiliary nozzle 130, the at least one sensor 150, the camera 160, the speaker 170, the plurality of security lights 180, the processing unit 191, the communication unit 192, and/or the storage unit 193.

Therefore, the intrusion prevention device 100 may prevent intrusion of the building before a crime is committed. Also, the intrusion prevention device 100 may prevent an owner and/or any other person usually in the building from getting injured.

The present general inventive concept may include an intrusion prevention device 100 running a program thereon and communicably connected to an external control device 10, the intrusion prevention device 100 including a main body 110 to removably connect to at least a portion of a building, a primary nozzle 120 movably disposed on at least a portion of the main body 110, at least one sensor 150 disposed on at least a portion of the main body 110 to detect a presence of at least one hostile third party, such that the primary nozzle 120 dispenses a lachrymatory agent toward the at least one hostile third party in response to a determination that a threat exists, a camera 160 disposed on at least a portion of the main body 110 to record the at least one hostile third party thereon using at least one of at least one picture and at least one video, a speaker 170 disposed on at least a portion of the main body 110 to emit at least one alarm sound in response to the determination that a threat exists, and at least one security light 180 disposed on at least a portion of the main body 110 to illuminate a surrounding area in response to the determination that a threat exists.

The main body 110 may include a top portion 111, a bottom portion 112 disposed at a first end on at least a portion of the top portion 111, a telescopic portion 113 telescopically disposed on at least a portion of a second end of the bottom portion 112 to move from retracted within the bottom portion 112 in a first position to at least partially extended away from the bottom portion 112 in a second position, and move from extended away from the bottom portion 112 in the second position to retracted within the bottom portion 112 in the first position, and a rotating portion 114 rotatably disposed on at least a portion of the telescopic portion 113 to rotate clockwise in a first rotating direction or rotate counterclockwise in a second rotating direction.

The intrusion prevention device 100 may further include an auxiliary nozzle 130 disposed on at least a portion of the rotating portion 114 to dispense the lachrymatory agent therefrom toward the at least one hostile third party in response to the determination that a threat exists.

The at least one sensor 150 may detect the presence of the at least one hostile third party based on movement within a predetermined distance away from the at least one sensor 150.

The at least one sensor 150 may detect the presence of the at least one hostile third party based on a sound of footsteps within a predetermined distance away from the at least one sensor 150.

The intrusion prevention device 100 may further include a control unit 190 disposed within at least a portion of the main body 110 to receive commands from the external control device 10 to configure at least one of the primary nozzle 120, the at least one sensor 150, the camera 160, the speaker 170, and the at least one security light 180.

The control unit 190 may determine the threat exists based on a combination of the presence of the at least one hostile third party and the at least one hostile third party is a person.

The control unit 190 may transmit a global positioning system (GPS) signal to another external control device 10 of at least one friendly third party in response to the determination that a threat exists.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An intrusion prevention device running a program thereon and communicably connected to an external control device, the intrusion prevention device comprising:
a main body to removably connect to at least a portion of a building;
a primary nozzle movably disposed on at least a portion of the main body;
at least one sensor disposed on at least a portion of the main body to detect a presence of at least one hostile third party, such that the primary nozzle dispenses a lachrymatory agent toward the at least one hostile third party in response to a determination that a threat exists;
a camera disposed on at least a portion of the main body to record the at least one hostile third party thereon using at least one of at least one picture and at least one video;
a speaker disposed on at least a portion of the main body to emit at least one alarm sound in response to the determination that a threat exists; and
at least one security light disposed on at least a portion of the main body to illuminate a surrounding area in response to the determination that a threat exists.

2. The intrusion prevention device of claim 1, wherein the main body comprises:
a top portion;
a bottom portion disposed at a first end on at least a portion of the top portion;
a telescopic portion telescopically disposed on at least a portion of a second end of the bottom portion to move from retracted within the bottom portion in a first position to at least partially extended away from the bottom portion in a second position, and move from extended away from the bottom portion in the second position to retracted within the bottom portion in the first position; and
a rotating portion rotatably disposed on at least a portion of the telescopic portion to rotate clockwise in a first rotating direction or rotate counterclockwise in a second rotating direction.

3. The intrusion prevention device of claim 2, further comprising:
an auxiliary nozzle disposed on at least a portion of the rotating portion to dispense the lachrymatory agent therefrom toward the at least one hostile third party in response to the determination that a threat exists.

4. The intrusion prevention device of claim 1, wherein the at least one sensor detects the presence of the at least one hostile third party based on movement within a predetermined distance away from the at least one sensor.

5. The intrusion prevention device of claim 1, wherein the at least one sensor detects the presence of the at least one hostile third party based on a sound of footsteps within a predetermined distance away from the at least one sensor.

6. The intrusion prevention device of claim 1, further comprising:
a control unit disposed within at least a portion of the main body to receive commands from the external control device to configure at least one of the primary nozzle, the at least one sensor, the camera, the speaker, and the at least one security light.

7. The intrusion prevention device of claim 6, wherein the control unit determines the threat exists based on a combination of the presence of the at least one hostile third party and the at least one hostile third party is a person.

8. The intrusion prevention device of claim 6, wherein the control unit transmits a global positioning system (GPS) signal to another external control device of at least one friendly third party in response to the determination that a threat exists.
